(19) United States
(12) Patent Application Publication
(10) Pub. No.: US 2018/0120244 A1
(43) Pub. Date: May 3, 2018

(54) X-RAY DIFFRACTION IMAGING OF MATERIAL MICROSTRUCTURES

(71) Applicant: KING ABDULLAH UNIVERSITY OF SCIENCE AND TECHNOLOGY, Thuwal (SA)

(72) Inventors: Laszlo VARGA, Thuwal (SA); Bonbien VARGA, Thuwal (SA); Victor CALO, Perth (AU)

(21) Appl. No.: 15/560,895

(22) PCT Filed: Apr. 14, 2016
(86) PCT No.: PCT/IB2016/052138

§ 371 Date: Sep. 22, 2017

Related U.S. Application Data
(60) Provisional application No. 62/148,340, filed on Apr. 16, 2015.

(51) Int. Cl. G01N 23/207

(52) U.S. Cl. CPC G01N 23/207; G01N 2223/413; G01N 2223/0566

(57) ABSTRACT

Various examples are provided for x-ray imaging of the microstructure of materials. In one example, a system for non-destructive material testing includes an x-ray source configured to generate a beam spot on a test item; a grid detector configured to receive x-rays diffracted from the test object; and a computing device configured to determine a microstructure image based at least in part upon a diffraction pattern of the x-rays diffracted from the test object. In another example, a method for determining a microstructure of a material includes illuminating a beam spot on the material with a beam of incident x-rays; detecting, with a grid detector, x-rays diffracted from the material; and determining, by a computing device, a microstructure image based at least in part upon a diffraction pattern of the x-rays diffracted from the material.

### CROSS REFERENCE TO RELATED APPLICATIONS

This application claims priority to, and the benefit of, co-pending U.S. provisional application entitled “X-RAY IMAGING OF MATERIAL MICROSTRUCTURES” having Ser. No. 62/148,340, filed Apr. 16, 2015, which is hereby incorporated by reference in its entirety.

### BACKGROUND

For manufactured components, quality control can include material testing of a sampled portion of the components. In general, evaluation of the material quality involves destructive testing of the sampled components to determine mechanical properties such as hardness. While this destructive testing can provide a statistical basis for evaluation of all of the manufactured components, it does not allow for actual testing of the components that are being supplied for use. Thus, their individual quality and safety remain unknown and cannot be guaranteed.

### SUMMARY

Embodiments of the present disclosure are related to x-ray imaging of material microstructures.

In one embodiment, among others, a system comprises an x-ray source configured to generate a beam spot on a test item; a detector configured to receive x-rays diffracted from the test object; and a computing device configured to determine a microstructure image based at least in part upon a diffraction pattern of the x-rays diffracted from the test object. The detector can be a grid detector. In one or more aspects of these embodiments, the computing device can be configured to determine a material property of the test object based at least in part upon the microstructure image. The material property can be determined by correlating the microstructure image with previously obtained material test information. The material property can be determined using pattern recognition. The grid detector can be configured to be repositioned to receive x-rays diffracted from the test object at a plurality of angles. In one or more aspects of these embodiments, the system can comprise a vertical axis double goniometer configured to adjust orientation of the test object with respect to the x-ray source. The detector can comprise a scintillator aligned with the x-rays diffracted from the test object. The detector can comprise a CCD camera.

In another embodiment, a method comprises illuminating a beam spot on the material with a beam of incident x-rays; detecting x-rays diffracted from the material; and determining a microstructure image based at least in part upon a diffraction pattern of the x-rays diffracted from the material. The diffracted x-rays can be detected with a grid detector. The microstructure image can be determined by a computing device. In one or more aspects of these embodiments, the method can comprise determining a property of the material based upon the microstructure image. The property of the material can be determined by correlating the microstructure image with microstructure image information obtained through destructive testing of corresponding material samples. A manufactured component can comprise the material. The microstructure image can be based at least in part upon diffraction patterns associated with x-rays diffracted from the material at a plurality of angles. In one or more aspects of these embodiments, the method can comprise adjusting orientation of the material with respect to the beam of incident x-rays. The x-rays diffracted from the material can be directed through a scintillator. The method can comprise magnifying a scintillated image produced by the x-rays directed through the scintillator. The detector can comprise a CCD camera.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B are graphical representations illustrating a micro x-ray diffraction (μXrD) system in accordance with various embodiments of the present disclosure.

FIG. 10 includes images of an example of an experimental setup of the μXrD system of FIG. 1A in accordance with various embodiments of the present disclosure.

FIG. 2 is a flow chart illustrating an example of μXrD imaging in accordance with various embodiments of the present disclosure.

FIG. 3 is a schematic block diagram of an example of a computing device in accordance with various embodiments of the present disclosure.

### DETAILED DESCRIPTION

Disclosed herein are various examples of methods and systems related to x-ray imaging of the microstructure of materials. Reference will now be made in detail to the description of the embodiments as illustrated in the drawings, wherein like reference numbers indicate like parts throughout the several views.

Mechanical properties of materials depend upon their microstructure. The current method of imaging the microstructure damages the component and material as well as requiring an extended period of time to complete. In general, a portion of the component is removed (or cut off) and polished before etching the material to emphasis the microstructure. The processed portion can then be imaged to see the details of the microstructure using a microscope. Destructive testing of the portion (e.g., indentation) may then be performed to determine the corresponding mechanical property. While this process can be used to correlate the mechanical properties and microstructure of the material being tested, the component being tested is no longer usable for its intended purpose.

Micro x-ray diffraction (μXrD) allows for imaging of a components microstructure while eliminating the destructive effects on the component. The micro x-ray diffraction is based upon Bragg diffraction and can provide a mapping of the x-ray beam diffraction by crystals in the material. The grain structure of the material can be identified using μXrD images of the material. A homogeneous crystal structure will produce a homogeneous distribution of the diffracted x-rays. In contrast, variations between and within the grains produce distortions that can be captured and used to identify material properties of the scanned component.

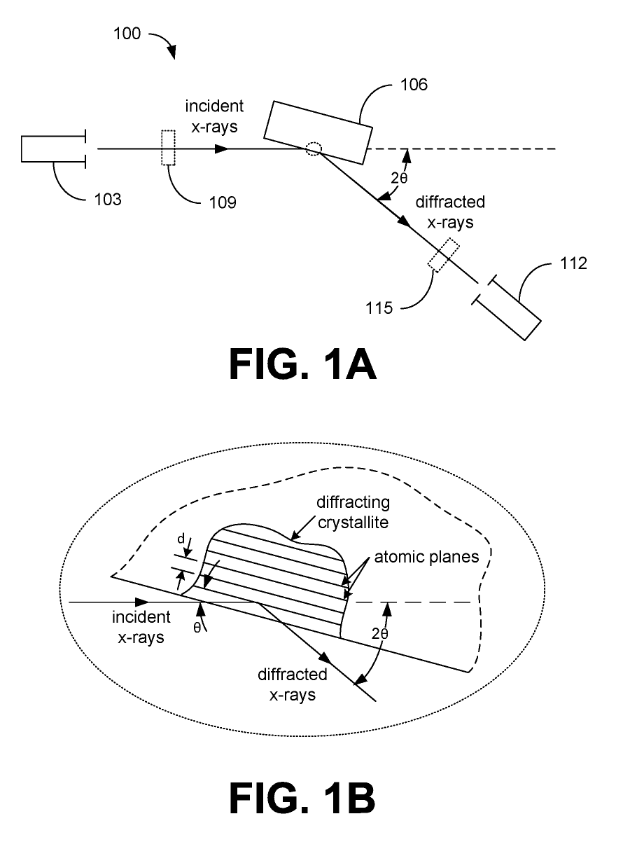

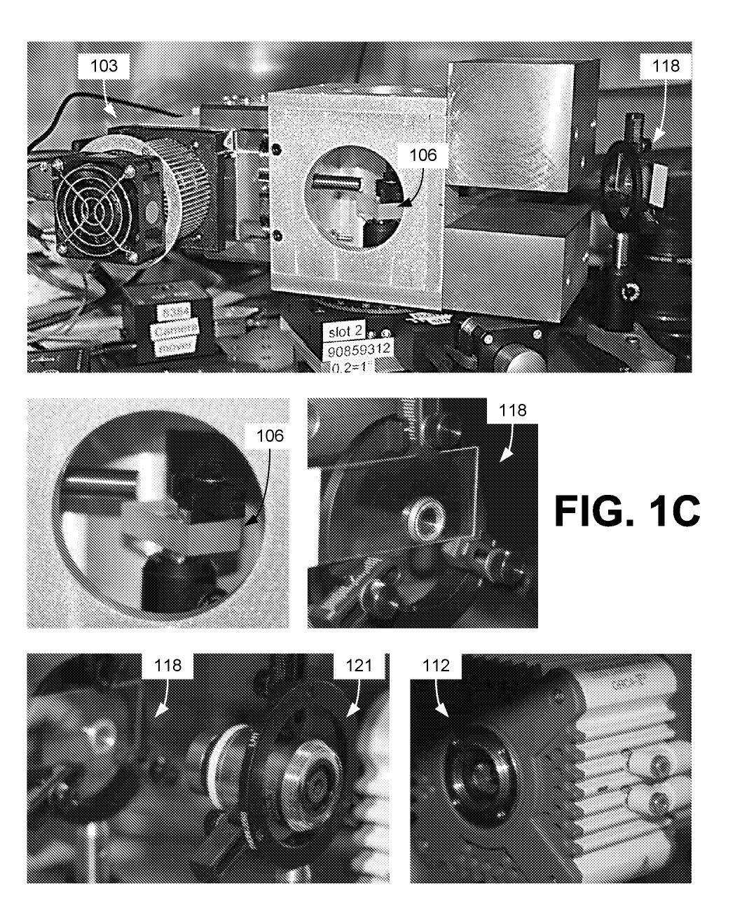

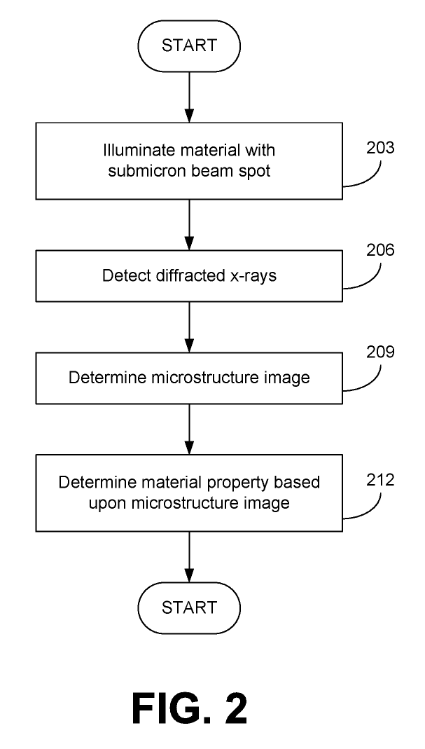

Referring to FIG. 1A, shown is an example of a system 100 that can be used for μXrD imaging. The system 100 includes an x-ray source 103 such as, e.g., an x-ray tube that can generate a beam spot on the tested component 106 (e.g., a substrate). The x-rays produced by the x-ray source 103 can pass through one or more collimators and/or filters 109 for conditioning of the incident beam of x-rays. The incident beam of x-rays can be directed onto the material at one or more predefined angles.

Upon striking the material of the component 106, x-rays are diffracted and can be collected by a detector 112. As illustrated in FIG. 1B, the incident x-rays strike the material at an angle of θ and are diffracted by the crystallite planes at an angle of 2θ. The incident x-rays can penetrate several planes of the material, allowing for analysis of the underlying structure of the tested component 106. The detector 112 can be a detector grid (or grid detector) for collection of a distribution of intensity peaks of the diffracted x-rays. For example, the detector grid can be an array of detectors with a size of about 100 nm to about 200 nm. The diffracted x-rays can be collected with a resolution of the μXrD, which can begin at about 60 micron. In various embodiments, a lens 115 can be positioned between the tested component 106 and the detector 112 to enlarge and/or focus the diffracted x-rays onto the detector 112. In some implementations, the lens 115 can be a two-component unit comprising a zone plate and a scintillator. A Fresnel zone plate can be placed in the route of the diffracted x-rays to function as an objective zone plate, and after this the scintillator can be placed before the detector 112 (e.g., a charge coupled device (CCD) camera).

A plurality of μXrD images can be obtained for each sample by changing the position and/or orientation of the tested component. The detected x-rays can be processed to determine a phase map of the imaged material based upon the intensity peaks. The phase map can provide a microstructure image of the material. After the images have been captured and processed, they may be analyzed to determine the material properties of the material being imaged. The analysis can include data mining of data store to determine the corresponding properties. Comparison of the captured image(s) with a data store of reference images (or other information) that have been correlated to measured properties such as, e.g., tensile strength, hardness, durability, etc. can be used to determine the material properties of the tested component 106. Various pattern recognition applications can be used to match the acquired image to the appropriate information in the data store. In some implementations, neural networks may be trained to determine material properties based upon the μXrD image(s).

For example, many high strength steels comprise a ferrite and martensitic microstructure with grains having two different phases (e.g., α-ferrite and cementite). The grain size and/or orientation can affect the material properties of the steel. By illuminating the tested component 106 with an 8 keV x-ray source 103 having a wavelength of 1.5 Å, the incident x-rays can penetrate the material surface by up to 4.2 μm. In this way, the material can be evaluated in three-dimensions (including multiple atomic planes below the surface of the material). The beam spot can be moved over the surface of the material to cover a defined area. Measurement of the intensity peaks by the detector grid allows for differentiation of the grain phases. A phase map of the material can be reconstructed from the fixed angle diffraction and this information can be used to establish the spatial coordinates of the origin of the intensity peaks. By understanding the phase structure of the examined material, it is possible to determine the corresponding material properties using, e.g., the test information from the data store.

The data store reference information can be obtained through evaluation and destructive testing of existing components. For example, μXrD imaging can be carried out on a plurality of sacrificial components, with multiple images being acquired for each sacrificial component at a variety of angles and positions. These μXrD images can be processed as discussed to obtain phase maps (or microstructure images) for the sacrificial components. Destructive testing may then be carried out to determine the material properties of each of the sacrificial components. This testing information can then be added to the data store and subsequently be used for subsequent identification using non-destructive testing. In some cases, the pattern recognition and/or neural networks can be trained to identify the material properties using the microstructure images (or phase maps) and testing information.

The system of FIG. 1A can be applied to a manufacturing situation where manufactured components 106 can be sequentially supplied to a μXrD imaging system in a predefined orientation. The x-ray source 103 and/or detector 112 can be mechanically repositioned about the current component to obtain one or more μXrD images of the material. For example, the x-ray source 103 and detector 112 may be mounted on rings that encircle a feed line. A manufactured component 106 may be moved into position along the feed line and held in place while the x-ray source 103 and/or detector 112 are adjusted to obtain the μXrD images. The tested component 106 may then move on down the feed line while the next manufactured component 106 moves into position for μXrD imaging. The μXrD images of the manufactured components 106 can then be processed to generate a phase map of the material, and used to determine the material properties through, e.g., pattern recognition with test information in a data store. Acceptance or rejection of the manufactured component may be based at least in part upon the determined material properties and defined material property criteria.

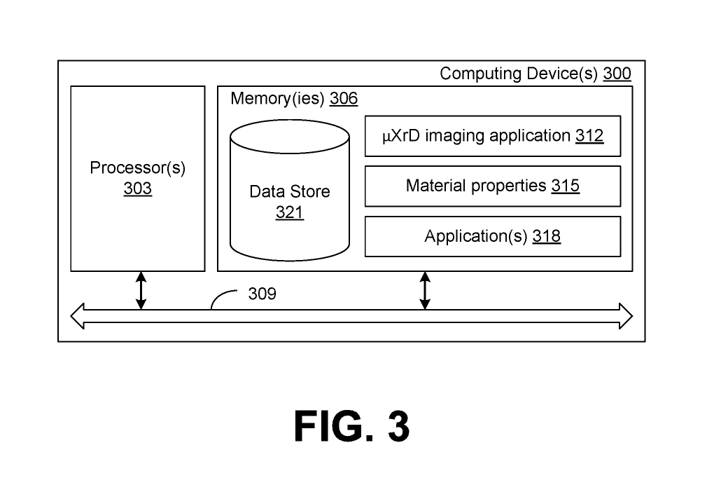

An experimental setup of the micro x-ray diffraction (μXrD) system was constructed to test proof of concept of the system for non-destructive material testing. FIG. 10 includes images of an example of the experimental setup. An x-ray source 103 with collimators was mounted on a vertical axis double goniometer. The double goniometer includes two turntable stages mounted with one common axis. The tested component 106 is placed in the vertical axis of the goniometers. With this arrangement, the incident beam of x-rays from the source 103 can be directed onto the material of the tested component 106 at one or more predefined angles. In this setup, the diffracted x-rays from the tested component 106 are directed through a scintillator 118. The scintillated image can be enlarged or magnified using an optic lens 121. The final image is captured using a CCD camera as the detector 112. During testing, the diffracted x-rays were detected.

Referring now to FIG. 2, shown is a flow chart illustrating an example of μXrD imaging of a tested component. Beginning with 203, a component or specimen being tested is illuminated by an x-ray beam. The material of the component or specimen is illuminated with a beam spot. The x-rays that are diffracted by the material are detected by, e.g., a grid detector at 206. The diffracted x-rays can provide a mapping of the microstructure of the material. The beam spot can be moved over the surface of the material to cover a defined area. At 209, a microstructure image is determined based at least in part upon the detected x-rays diffracted from the material. A phase map of the material can be reconstructed from the fixed angle diffraction and this information can be used to establish the spatial coordinates of the origin of the intensity peaks.

One or more material properties of the sample or specimen can be determined using microstructure images. Image analysis of retrieved microstructure images and those in image banks where correlations of physical properties and image features has been carried out. Image analysis and correlation will inform the user of the sample's physical properties, such as tensile strength, hardness and durability. In some implementations, a pattern recognition application may be used to match the acquired image to the appropriate information in the data store. In other implementations, a neural network may be used to determine the material properties based upon the μXrD image(s).

With reference now to FIG. 3, shown is a schematic block diagram of a computing device 300 according to an embodiment of the present disclosure. The computing device 300 includes at least one processor circuit, for example, having a processor 303 and a memory 306, both of which are coupled to a local interface 309. To this end, the computing device 300 may comprise, for example, at least one server computer or like device. The local interface 309 may comprise, for example, a data bus with an accompanying address/control bus or other bus structure as can be appreciated.

Stored in the memory 306 are both data and several components that are executable by the processor 303. In particular, stored in the memory 306 and executable by the processor 303 are a μXrD imaging application 312, one or more material properties 315 that may be utilized and/or determined during image analysis, and potentially other applications 318. Also stored in the memory 306 may be a data store 321 including, e.g., images and other data. In addition, an operating system may be stored in the memory 306 and executable by the processor 303. It is understood that there may be other applications that are stored in the memory and are executable by the processor 303 as can be appreciated.

Where any component discussed herein is implemented in the form of software, any one of a number of programming languages may be employed such as, for example, C, C++, C#, Objective C, Java®, JavaScript®, Perl, PHP, Visual Basic®, Python®, Ruby, Delphi®, Flash®, or other programming languages. A number of software components are stored in the memory and are executable by the processor 303. In this respect, the term “executable” means a program file that is in a form that can ultimately be run by the processor 303. Examples of executable programs may be, for example, a compiled program that can be translated into machine code in a format that can be loaded into a random access portion of the memory 306 and run by the processor 303, source code that may be expressed in proper format such as object code that is capable of being loaded into a random access portion of the memory 306 and executed by the processor 303, or source code that may be interpreted by another executable program to generate instructions in a random access portion of the memory 306 to be executed by the processor 303, etc. An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory is defined herein as including both volatile and nonvolatile memory and data storage components. Volatile components are those that do not retain data values upon loss of power. Nonvolatile components are those that retain data upon a loss of power. Thus, the memory 306 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (M RAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 303 may represent multiple processors 303 and the memory 306 may represent multiple memories 306 that operate in parallel processing circuits, respectively. In such a case, the local interface 309 may be an appropriate network that facilitates communication between any two of the multiple processors 303, between any processor 303 and any of the memories 306, or between any two of the memories 306, etc. The processor 303 may be of electrical or of some other available construction.

Although portions of the μXrD imaging application 312, material properties 315, and other various systems described herein may be embodied in software or code executed by general purpose hardware, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The μXrD imaging application 312 and material properties 315 can comprise program instructions to implement logical function(s) and/or operations of the system. The program instructions may be embodied in the form of source code that comprises human-readable statements written in a programming language or machine code that comprises numerical instructions recognizable by a suitable execution system such as a processor 703/803 in a computer system or other system. The machine code may be converted from the source code, etc. If embodied in hardware, each block may represent a circuit or a number of interconnected circuits to implement the specified logical function(s).

Also, any logic or application described herein, including the μXrD imaging application 312 and material properties 315 that comprises software or code can be embodied in any non-transitory computer-readable medium for use by or in connection with an instruction execution system such as, for example, a processor 303 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A system for non-destructive material testing, the system comprising:
an x-ray source configured to generate a beam spot on a test item;
a grid detector configured to receive x-rays diffracted from the test object; and
a computing device configured to determine a microstructure image based at least in part upon a diffraction pattern of the x-rays diffracted from the test object.

2. The system of claim 1, wherein the computing device is configured to determine a material property of the test object based at least in part upon the microstructure image.

3. The system of claim 2, wherein the material property is determined by correlating the microstructure image with previously obtained material test information.

4. The system of claim 2, wherein the material property is determined using pattern recognition.

5. The system of claim 1, wherein the grid detector is configured to be repositioned to receive x-rays diffracted from the test object at a plurality of angles.

6. The system of claim 1, comprising a vertical axis double goniometer configured to adjust orientation of the test object with respect to the x-ray source.

7. The system of claim 1, wherein the grid detector comprises a scintillator aligned with the x-rays diffracted from the test object.

8. The system of claim 1, wherein the grid detector comprises a CCD camera.

9. A method for determining a microstructure of a material, the method comprising:
illuminating a beam spot on the material with a beam of incident x-rays;
detecting, with a grid detector, x-rays diffracted from the material; and
determining, by a computing device, a microstructure image based at least in part upon a diffraction pattern of the x-rays diffracted from the material.

10. The method of claim 9, comprising determining a property of the material based upon the microstructure image.

11. The method of claim 10, wherein the property of the material is determined by correlating the microstructure image with microstructure image information obtained through destructive testing of corresponding material samples.

12. The method of claim 9, wherein a manufactured component comprises the material.

13. The method of claim 9, wherein the microstructure image is based at least in part upon diffraction patterns associated with x-rays diffracted from the material at a plurality of angles.

14. The method of claim 9, comprising adjusting orientation of the material with respect to the beam of incident x-rays.

15. The method of claim 9, wherein x-rays diffracted from the material are directed through a scintillator.

16. The method of claim 15, comprising magnifying a scintillated image produced by the x-rays directed through the scintillator.

17. The method of claim 9, wherein the grid detector comprises a CCD camera.
